(19) United States
(12) Patent Application Publication
(10) Pub. No.: US 2026/0328561 A1
(43) Pub. Date: Oct. 22, 2026

(54) DISTANCE MEASURING DEVICE

(71) Applicant: Panasonic Intellectual Property Management Co., Ltd., Osaka (JP)

(72) Inventors: SHOTA YAMADA, Shiga (JP); SHINZO KOYAMA, Osaka (JP); MASAHARU FUKAKUSA, Kumamoto (JP)

(21) Appl. No.: 19/110,457

(22) PCT Filed: Dec. 5, 2023
(86) PCT No.: PCT/JP2023/043421

§ 371 Date: Mar. 11, 2025

(30) Foreign Application Priority Data
Jan. 25, 2023 (JP) 2023-009592

(51) Int. Cl. G01B 11/25; G01B 11/245; G01C 3/06

(52) U.S. Cl. CPC G01B 11/2509; G01B 11/245; G01C 3/06

(57) ABSTRACT

A distance measuring device includes a light projector configured to project light containing light beams having wavelength bands different from one another, first and second image-capture units arranged to have fields of view thereof overlapping each other, and a lens configured to form an image of an object on a sensing surface of the first image-capture unit. The light projector is configured to project patterned light on an area in which the object exists and the fields of view of the first and second image-capture units overlap each other. The patterned light contains the light beams distributed in a predetermined pattern. The sensing surface of the first image-capture unit and a principal plane of the lens are not parallel to each other.

### TECHNICAL FIELD

The present disclosure relates to a distance measuring device.

### BACKGROUND ART

A distance measuring device configured to measure a distance to an object by processing images captured by a stereo camera has been known. This device detects a disparity from images captured by cameras. A pixel block having a highest correlation with an object pixel block on one image (a reference image) is searched on another image (a search image). The position of the object pixel block is set as a reference position, and a search range is set from the reference position in a direction in which the cameras are apart from each other. A pixel misalignment amount of a pixel block extracted by the search with respect to the reference position is detected as the disparity. A distance to the object is calculated based on this disparity by the triangulation method.

A stereo camera system (a distance measuring device) disclosed in PTL 1 satisfies a Scheimpflug condition along at least one of beam paths of sensor regions and lenses.

### CITATION LIST

### Patent Literature

PTL 1: Japanese Patent Laid-Open Publication No. 2022-536887

### SUMMARY OF INVENTION

The stereo camera system disclosed in PTL 1 includes an optical system arranged to satisfy the Scheimpflug condition, and may simultaneously focus on an object existing in a short distance and an object existing in a long distance.

However, PTL 1 is silent about a configuration necessary to increase resolution.

A distance measuring device according to an aspect of the present disclosure includes a light projector configured to project light containing light beams having wavelength bands different from one another, a first image-capture unit and a second image-capture unit arranged to have fields of view thereof overlapping each other, and a lens configured to form an image of an object on a sensing surface of the first image-capture unit. The light projector is configured to project patterned light on an area in which the object exists and the fields of view of the first image-capture unit and the second image-capture unit overlap each other, the patterned light containing the light beams distributed in a predetermined pattern. The sensing surface of the first image-capture unit and a principal plane of the lens are not parallel to each other.

The distance measuring device according to the present disclosure has a high resolution.

### BRIEF DESCRIPTION OF DRAWINGS

FIG. 1 illustrates a basic configuration of a distance measuring device according to a first exemplary embodiment.

FIG. 2 illustrates a configuration of the distance measuring device according to the first embodiment.

FIG. 3 illustrates a schematic configuration of the distance measuring device according to the first embodiment.

FIG. 4 schematically illustrates a method of setting a pixel block on a first image according to the first embodiment.

FIG. 5 illustrates a configuration of a filter according to the first embodiment.

FIG. 6 illustrates a first image and a second image according to the first embodiment.

FIG. 7 is a diagram for explaining wavelength bands output from a light source according to the first embodiment.

FIG. 8 is a flowchart for explaining a calibration processing according to the first embodiment.

FIG. 9 is a diagram for explaining a method of searching an object pixel block according to the first embodiment.

FIG. 10 illustrates an example of patterned light according to a second exemplary embodiment.

### DESCRIPTION OF EMBODIMENTS

Exemplary embodiments of the present invention will be detailed below with reference to the accompanying drawings. The exemplary embodiments described below are mere examples, and are not intended to limit the present invention, applications of the present invention or uses of the present invention.

### First Exemplary Embodiment

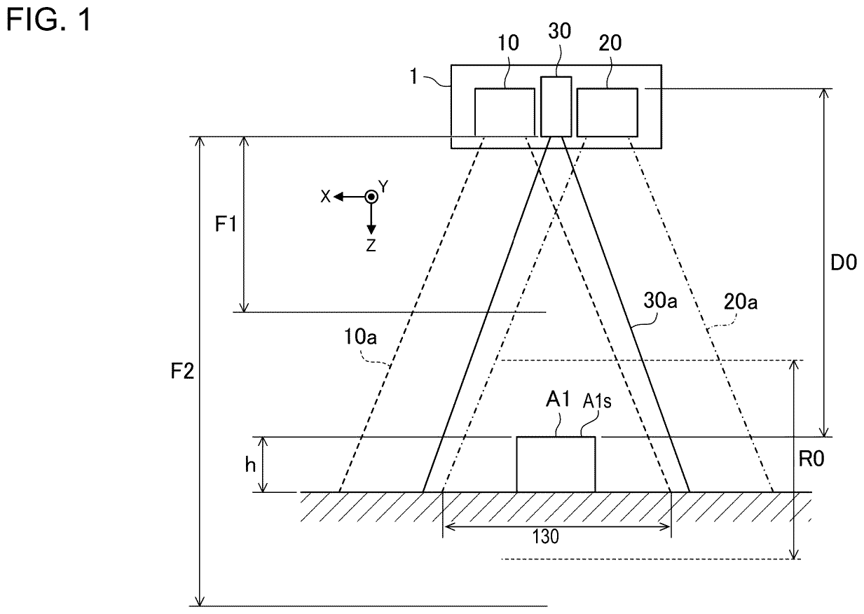

FIG. 1 illustrates a basic configuration of a distance measuring device 1 according to a first exemplary embodiment.

As shown in FIG. 1, the distance measuring device 1 includes a first image-capture unit 10, a second image-capture unit 20, and a light projector 30.

The first image-capture unit 10 is configured to capture an image in an area of field of view 10a directed in a positive direction of a Z-axis. The second image-capture unit 20 is configured to capture an image in an area of field of view 20a directed in the positive direction of the Z-axis. The first image-capture unit 10 and the second image-capture unit 20 are apart from each other by a predetermined distance (a baseline length) in an X-axis direction such that the fields of view 10a and 20a overlap each other. The shooting direction of the first image-capture unit 10 may incline slightly toward the second image-capture unit 20 from the positive direction of the Z-axis. The shooting direction of the second image-capture unit 20 may incline slightly toward the first image-capture unit 10 from the positive direction of the Z-axis. Positions of the first image-capture unit 10 and the second image-capture unit 20 in the Z-axis direction are the same, and positions of the first image-capture unit 10 and the second image-capture unit 20 in a Y-axis direction are the same.

The light projector 30 is configured to project patterned light 30a containing light beams distributed in a predetermined pattern to an area 130 in which the field of view 10a and the field of view 20a overlap each other. The direction of the patterned light 30a projected by the light projector 30 is the positive direction of the Z-axis. The patterned light 30a is projected on a surface A1s of an object A1 existing in the area in which the fields of view 10a and 20a overlap each other.

The distance measuring device 1 is configured to measure a distance D0 to the object A1 by a stereo correspondence point search using images captured by the first image-capture unit 10 and the second image-capture unit 20. The patterned light 30a is projected from the light projector 30 on the surface A1s of the object A1. Therefore, the pattern of the patterned light 30a appears on each of the images captured by the first image-capture unit 10 and the second image-capture unit 20. This configuration allows the stereo correspondence point search to be performed accurately even in the case where the surface A1s of the object A1 is plain, so that the distance D0 to the surface A1s of the object A1 may be accurately measured.

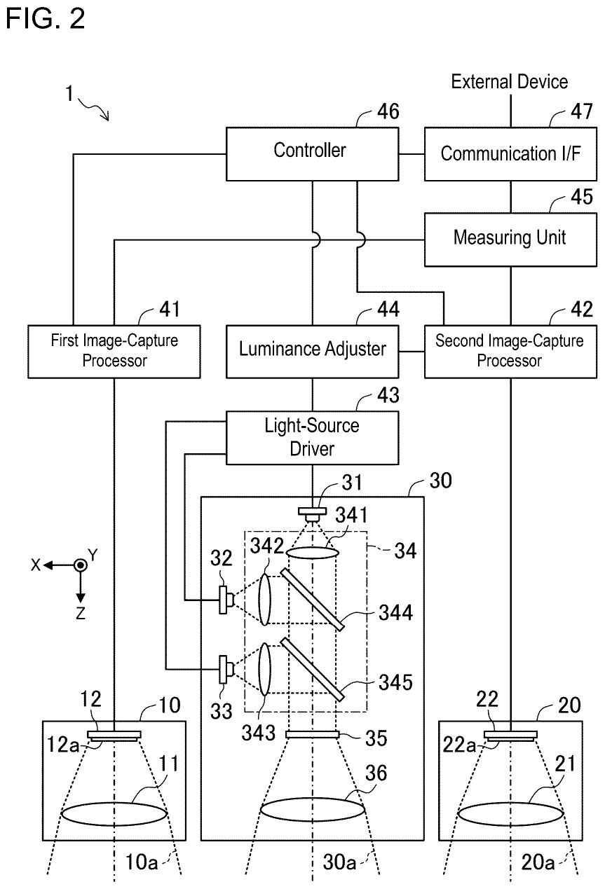

FIG. 2 illustrates a configuration of the distance measuring device 1 according to the first embodiment.

The first image-capture unit 10 includes an image-capture lens 11 and an image-capture element 12. The image-capture lens 11 has a focal distance and configured to focus light from the field of view 10a on an image-capture surface 12a (a sensing surface) of the image-capture element 12. The image-capture lens 11 is not necessarily a single lens, and may be a combination of plural lenses. The image-capture element 12 is a monochrome image sensor. The image-capture element 12 may be implemented by, for example, a CMOS image sensor. The image-capture element 12 may be implemented by a CCD.

The second image-capture unit 20 has the same configuration as the first image-capture unit 10. The second image-capture unit 20 includes an image-capture lens 21 and an image-capture element 22. The image-capture lens 21 has the same focal distance as the first image-capture lens 11 and is configured to focus light from the field of view 20a on an image-capture surface 22a (a sensing surface) of the image-capture element 22. The image-capture lens 21 is not necessarily a single lens, and may be a combination of plural lenses. The image-capture element 22 is a monochrome image sensor. The image-capture element 22 may be implemented by, for example, a CMOS image sensor. The image-capture element 22 may be implemented by a CCD.

The light projector 30 includes light sources 31-33, an optical system 34, a filter 35, and a projection lens 36.

The light sources 31-33 are configured to output respective light beams having wavelength bands different from one another. For example, the light source 31 is configured to output a light beam having a wavelength band around red, the light source 32 outputs a light beam having a wavelength band around green, and the light source 33 outputs a light beam having a wavelength band around blue. Each of the light sources 31-33 may be implemented by, for example, a light emitting diode. Each of the light sources 31-33 may be implemented by another light source, such as a semiconductor laser.

The optical system 34 includes collimator lenses 341-343 and dichroic mirrors 344 and 345. The collimator lenses 341-343 are configured to convert the light beams emitted from the light sources 31-33 to light beams substantially parallel to one another, respectively. The dichroic mirror 344 is configured to transmit light beam entering from the collimator lens 341 and reflect light beam entering from the collimator lens 342. The dichroic mirror 345 is configured to transmit light beam entering from the dichroic mirror 344 and reflect light beam entering from the collimator lens 343. The light beams emitted from the light sources 31-33 are thus collected and guided to the filter 35.

The filter 35 is configured to produce, from the light beams guided from the optical system 34 and containing wavelength bands different from one another, patterned light 30a containing light regions having wavelength bands different from one another and distributed in a predetermined pattern.

The projection lens 36 is configured to project the patterned light 30a produced by the filter 35. The projection lens 36 is not necessarily a single lens, and may be a combination of plural lenses.

The distance measuring device 1 includes, as elements of constructing its circuit block, a first image-capture processor 41, a second image-capture processor 42, a light source driver 43, a luminance adjuster 44, a measuring unit 45, a controller 46, and a communication interface 47.

The first image-capture processor 41 and the second image-capture processor 42 control the image-capture elements 12 and 22, respectively, and perform processing operations, such as a luminance correction and a camera calibration, on image signals of first and second images output from the image-capture elements 12 and 22, respectively.

The light source driver 43 is configured to drive the light sources 31-33 with drive currents with values set by the luminance adjuster 44, respectively.

The luminance adjuster 44 is configured to set values of the drive currents driving the light sources 31-33 of the light source driver 43 based on pixel signals (luminance signals) of the second image input from the second image-capture processor 42. The luminance adjuster 44 is configured to set the values of the respective drive currents (the amounts of the emitting light beams) for driving the light sources 31-33 such that the maximum luminance based on the light beams from the light sources 31-33 does not saturate, where the maximum luminance is obtained based on the pixel signals from the second image-capture unit 20.

The measuring unit 45 is configured to perform a stereo correspondence point search by comparing the first image and the second image which are input from the first image-capture processor 41 and the second image-capture processor 42, respectively, to obtain a distance to the surface A1s of the object A1 for each of pixel blocks in the first image. The measuring unit 45 is configured to send data of the obtained distance for all pixel blocks to an external device via the communication interface 47.

In other words, the measuring unit 45 sets a pixel block as an object to obtain a distance thereto (hereinafter referred to as “object pixel block”) on the first image, and searches a pixel block corresponding to the object pixel block, or a pixel block that best matches the object pixel block (hereinafter referred to as “match pixel block”) in a search area defined on the second image. The measuring unit 45 obtains a pixel misalignment amount between the match pixel block extracted from the second image by the above-described search and a pixel block that exists on the same position as the object block on the second image (hereinafter referred to as “reference pixel block”), and calculates a distance to the surface A1s of the object A1 at the position of the object pixel block based on the obtained pixel misalignment amount.

Each of the measuring unit 45 and the communication interface 47 may be implemented by a semiconductor integrated circuit constructed by a field programmable gate array (FPGA). Alternatively, each of these parts may be implemented by another semiconductor integrated circuit, such as a digital signal processor (DSP), a graphics processing unit (GPU) or an application specific integrated circuit (ASIC).

The controller 46 is implemented by, e.g., a microcomputer, and controls each part of the distance measuring device according to a particular program stored in a built-in memory.

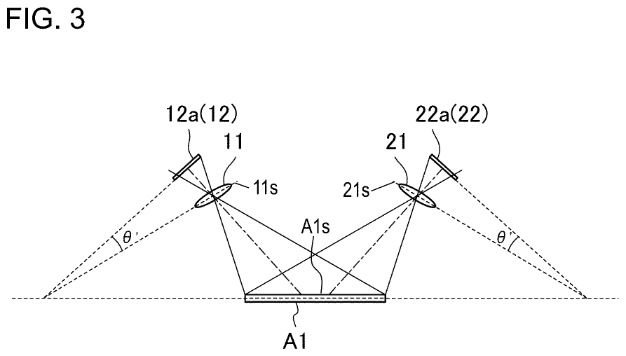

FIG. 3 illustrates a schematic configuration of the distance measuring device according to the first embodiment. FIG. 3 shows an arrangement of the first image-capture unit 10, the second image-capture unit 20, and the object A1. A shown in FIG. 3, the first image-capture unit 10 is arranged such that extension lines extending from the principal plane 11s of the image-capture lens 11, the image-capture surface 12a of the image-capture element 12 of the first image-capture unit 10, and the surface A1s of the object A1 intersect at one point. Similarly, the second image-capture unit 20 is arranged such that extension lines extending from the principal plane 21s of the image-capture lens 21, the image-capture surface 22a of the image-capture element 22 of the second image-capture unit 20, and the surface A1s of the object A1 intersect at one point. The image-capture surface 12a (the sensing surface) and the principal plane 11s of the image-capture lens 11 of the first image-capture unit are arranged not parallel to each other, and the image-capture surface 22a (the sensing surface) and the principal plane 21s of the image-capture lens 21 of the second image-capture unit 20 are arranged not parallel to each other. In more detail, each of the first image-capture unit 10 and the second image-capture unit 20 is arranged so as to satisfy the Scheimpflug condition with respect to the surface A1s of the object A1. In this arrangement, each of the first image-capture unit 10 and the second image-capture unit 20 can focus on both of an object far from the image-capture unit and an object close to the image-capture unit. In the example shown in FIG. 3, each of an angle formed by the principal plane 11s of the image-capture lens 11 and the image-capture surface 12a of the image-capture element 12 and an angle formed by the principal plane 21s of the image-capture lens 21 and the image-capture surface 22a of the image-capture element 22 is the same angle θ′.

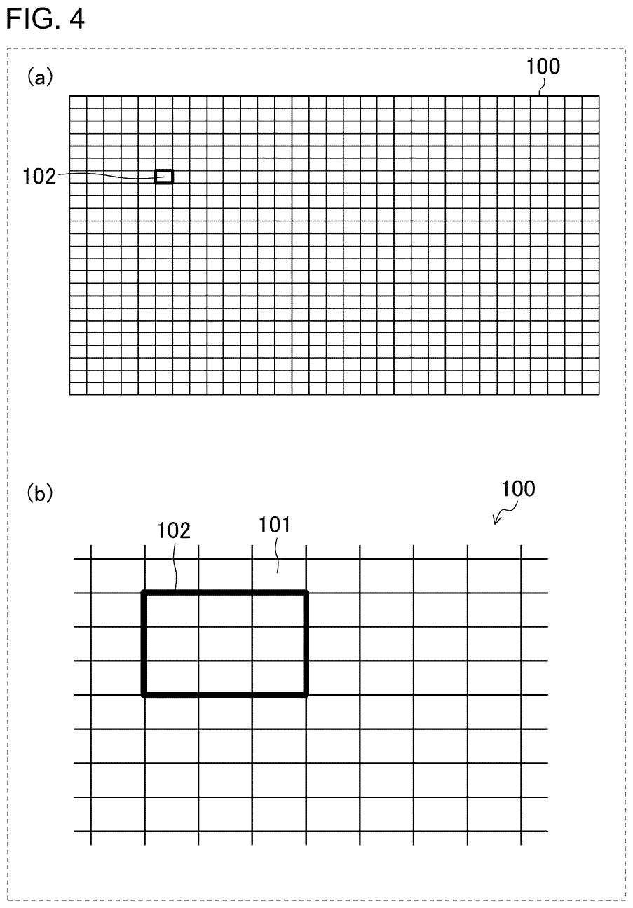

FIG. 4 is a diagram schematically illustrating a method of setting a pixel block on the first image according to the first embodiment. FIG. 4(a) illustrates a method of setting a pixel block 102 in the entire first image 100, and FIG. 4(b) illustrates an enlarged partial area in the first image 100. The image shown in FIG. 4 is the first image 100 after having been subjected to a later-described calibration processing.

As shown in FIG. 4(a) and 4(b), the first image 100 is divided to plural pixel blocks 102 each having a predetermined number of pixels 101. Each of the pixel regions 101 corresponds to one pixel on the image-capture element 12. In other words, one pixel region 101 is a minimum unit of the first image 100. In the example shown in FIG. 3(a) and 3(b), one pixel block 102 has nine (9) pixel regions 101 arranged in a matrix of three rows and three columns. However, the number of pixel regions 101 in one pixel block 102 may not be limited to this number.

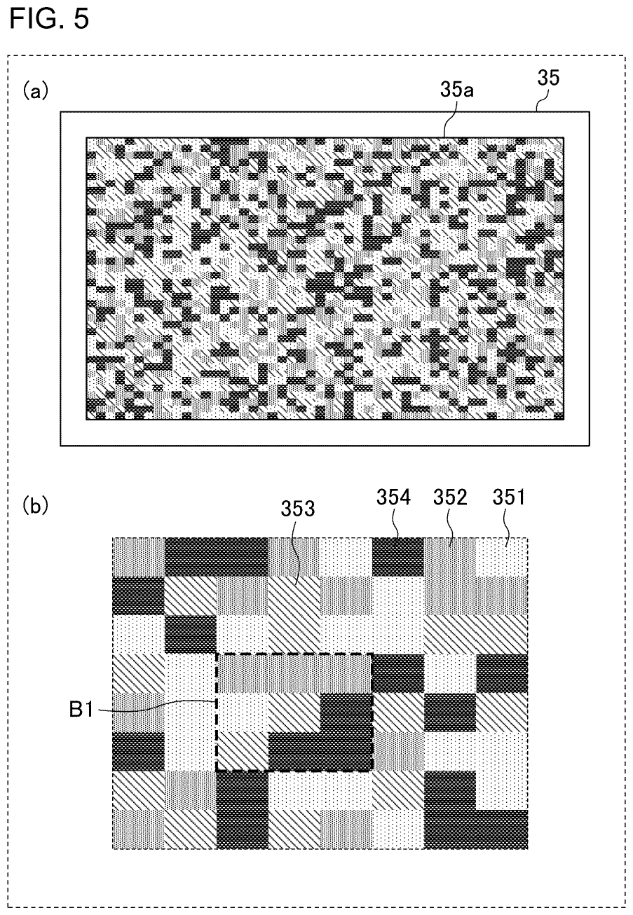

FIG. 5 illustrates a configuration of a filter according to the first embodiment. FIG. 5(a) schematically shows a configuration of the filter 35. FIG. 5(b) is an enlarged view of a partial area of the filter 35 shown in FIG. 5(a). FIG. 5(a) and 5(b) illustrate the filter 35 when viewed from a light incident surface 35a.

As shown in FIG. 5(a) and 5(b), the filter 35 has plural filter regions 351-354 having respective predetermined patterns. In FIG. 5(a) and 5(b), the filter regions 351-354 are indicated by hatching different from one another. The filter regions 351-354 selectively transmit light beams of with wavelengths different from one another to form light regions of hues different from one another. In this example, the filter region 351 forms a light region corresponding to the “red” hue, the filter region 352 forms a light region corresponding to the “orange” hue, the filter region 353 forms a light region corresponding to the “green” hue, and the filter region 354 forms a light region corresponding to the “blue” hue. Characteristics of the light sources 31-33 and the filter regions 351-354 will be described later.

The sizes of the filter regions 351-354 may be set, for example, to substantially correspond to the sizes of one pixel block on each of the image-capture elements 12 and 22. For example, a region B1 indicated by broken lines in FIG. 5(b) corresponds to a pixel block constructed by vertically aligned three pixels and horizontally aligned three pixels on each of the image-capture elements 12 and 22 (each of the pixel blocks 102 and 202 used for the above-described stereo correspondence point search). In other words, in the case where the distance D0 to the surface A1s of the object A1 is a standard distance (for example, a middle distance in the measuring range), the light in the region B1 is projected on the region of the pixel block constructed by vertically aligned three pixels and horizontally aligned three pixels on each of the image-capture elements 12 and 22. The size of each of the filter regions 351-354 does not necessarily correspond to one pixel. The size of each of the filter regions 351-354 may be larger than or smaller than the size corresponding to one pixel block. Further, although the filter regions 351-354 shown in FIG. 5(b) have rectangular shapes and the same size, the sizes of the filter regions 351-354 may be different from one another. Also, the shapes of the filter regions 351-354 may be other shapes, such as square shapes or circular shapes.

Filter regions 351-354 may be arranged preferably such that each of all regions B1 corresponding to all pixel blocks used for the stereo correspondence point search contains filter regions which are different from one another, and more preferably such that each of those regions B1 contains all the filter regions 351-354. The pattern of arranging the filter regions contained in each of the regions B1 corresponding to the pixel blocks may preferably be unique (random) on a pixel block by pixel block basis at each search position in at least the search range R0 of the stereo correspondence point search (refer to FIG. 3).

In the condition that the filter regions 351-354 are arranged as described above, the luminance distribution of the light in each pixel block may be unique on a pixel block by pixel block basis by the luminance values of the light beams passed through the filter regions 351-354 different from one another, while will be described later. This configuration enhances accuracy of the stereo correspondence point search, thus enhancing accuracy of measuring the distance.

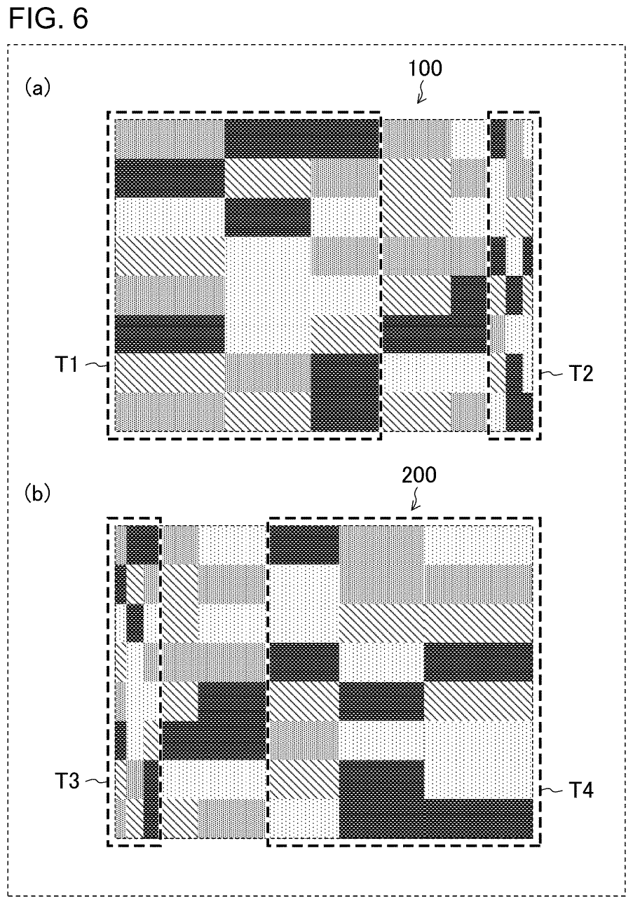

FIG. 6(a) shows the first image 100 according to the first embodiment, and FIG. 6(b) shows the second image 200 according to the first embodiment. The first image 100 and the second image 200 shown in FIG. 6(a) and 6(b) are the images before being processed by the later described calibration processing.

As shown in FIG. 6(a), in the first image 100, the width of the light dot in the lateral direction decreases from the right end in the figure toward the left end in the figure. As shown in FIG. 5(b), in the second image 200, the width of the light dot in the lateral direction becomes decreases from the left end in the figure toward the right end in the figure. In the first image 100, the width of the light dot in the lateral direction in a first region T1 located on the left side is larger, and the width of the light dot in the lateral direction in a second region T2 located on the right side is smaller. In the second image 200, the width of the light dot in the lateral direction in a third region T3 located on the left side is smaller, and the width of the light dot in the lateral direction in a fourth region T4 located on the right side is larger. r. The reason for this is as follows. Since the first image-capture unit 10 and the second image-capture unit 20 are arranged with respect to the object A1 to satisfy the Scheimpflug condition, the width in the width direction of the light dot closer to the image-capture unit becomes larger, and the width in the width direction of the light dot farther from the image-capture unit becomes smaller. Accordingly, in each of the first image 100 and the second image 200, the resolution reduces at the position farther from the image-capture unit. According to the first embodiment, reduction of the resolution can be suppressed by executing the later described calibration processing even in the case where the optical system is arranged to satisfy the Scheimpflug condition.

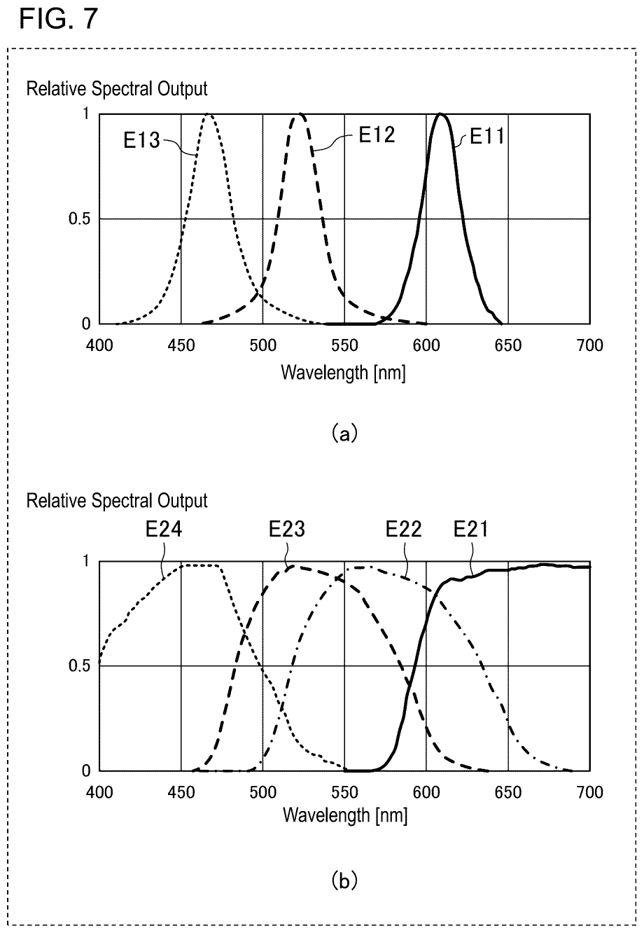

FIG. 7 is a diagram for explaining wavelength bands output from a light source according to the first embodiment.

FIG. 7(a) is a graph showing spectral outputs of the light sources 31-33. The spectral outputs from the light sources 31, 32 and 33 are indicated by a solid line (E11), a dot line (E12) and a broken line (E12), respectively. The vertical axis of the graph is normalized by the maximum output of the light source 31.

The light source 31 outputs light with a center wavelength of about 610 nm and a wavelength band width of about 80 nm. The light source 32 outputs light with a center wavelength of about 520 nm and a wavelength band width of about 150 nm. The light source 33 outputs light with a center wavelength of about 470 nm and a wavelength band width of about 100 nm.

FIG. 7 is a graph showing spectral transmittances of the filter regions 351-354. The spectral transmittances of the filter regions 351, 352, 353 and 354 are indicated by a solid line (E21), a dot-and-dash line (E22), a dot line (E23) and a broken line (E24), respectively. The vertical axis of the graph is normalized by the maximum transmittance of the filter region 351.

In the filter region 351, the transmittance increases as the wavelength increases in the wavelength region at and longer than about 570 nm and that the maximum transmittance is maintained in the wavelength region at and longer than about 650 nm. The filter region 351 mainly transmits the light from the light source 31 to form a light area (the light dot) of the “red” hue. The filter region 352 has spectral characteristics in which it has a maximum transmittance at about 560 nm and that its transmitting wavelength band width of about 160 nm. The filter region 352 mainly transmits the light from the light source 31 and the light from the light source 32 to form a light area (the light dot) of the “orange” hue. The filter region 353 has spectral characteristics in which it has a maximum transmittance at about 520 nm and that its transmitting wavelength band width of about 150 nm. The filter region 353 mainly transmits the light from the light source 32 to form a light area (the light dot) of the “green” hue. The filter region 354 has such spectral characteristics that it has a maximum transmittance at about 460 nm and that its transmitting wavelength band width is about 150 nm. The filter region 354 mainly transmits the light from the light source 33 to form a light area (the light dot) of the “blue” hue.

The filter having four spectral transmittances has been described above, but the filter may not be limited to the above-described filter. For example, another filter having spectral transmittances transmitting plural wavelength regions in the wavelength regions of the light sources 31-33 may be added to form a larger number of light areas (the light dots) of different hues.

Next, a method of calculating a distance indicating value based on the first image 100 and the second image 200 by measuring unit 45 will be described below.

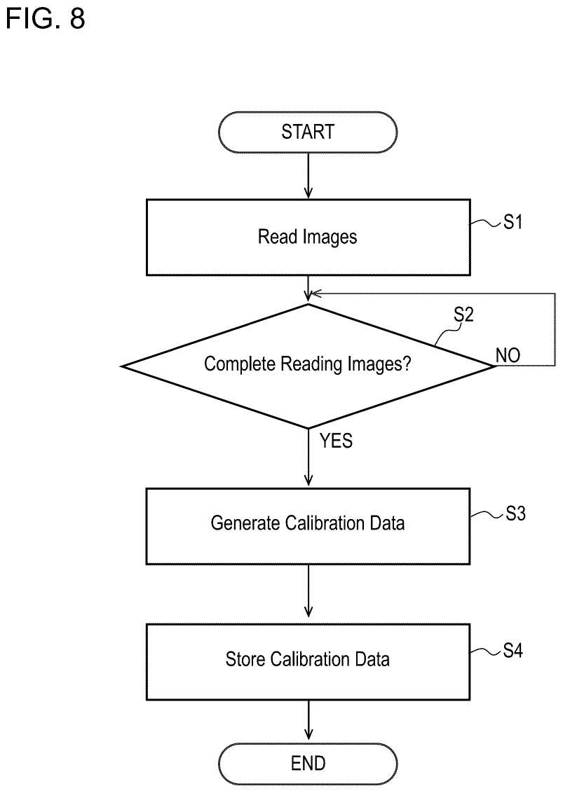

FIG. 8 is a flowchart for explaining a calibration processing according to the first embodiment.

The measuring unit 45 reads the first image 100 captured by the first image-capture unit 10 and the second image 200 captured by the second image-capture unit 200 (step S1). Specifically, the measuring unit 45 reads the first image 100 shown in FIG. 6(a) and the second image 200 shown in FIG. 6(b).

After having completed the reading of the first image 100 and the second image 200 (“Yes” in step S2), the measuring unit 45 generates calibration data (step S3). Specifically, the measuring unit 45 replaces the image of the third region T3 in the second image 200 by the image of the first region T1 in the first image 100 to interpolate the third region T3, which is a part of the second image 200, by the first region T1, which is a part of the first image 100. Similarly, the measuring unit 45 replaces the image of the second region T2 in the first image 100 by the image of the fourth region T4 in the second image 200 to interpolate the second region T2, which is a part of the first image 100, by the fourth region T4, which is a part of the second image 200. In other words, the measuring unit 45 replaces the second region T2, which is a low-resolution region in the first image 100, by the fourth region T4, which is a high-resolution region in the second image 200. Similarly, the measuring unit 45 replaces the third region T3, which is a low-resolution region in the second image 200, by the first region T1, which is a high-resolution region in the first image 100. This configuration increases the resolutions of both the first image 100 and the second image 200 while increasing the depth of field of the distance measuring device. Then, the measuring unit 45 normalizes the first image 100 and the second image 200. Specifically, the measuring unit 45 performs a processing to make the lateral width of the image of each light dot in the first image 100 and the second image 200 to be the same. The above-described processing converts the first image 100 shown in FIG. 6(a) and the second image 200 shown in FIG. 6(b) to the first image 100 shown in FIG. 5(a) and the second image 200 shown in FIG. 5(b), respectively.

The measuring unit 45 stores the first image 100 and the second image 200 generated in step S3 as the calibration data (step S4).

After step S4, the measuring unit 45 reads out the first image data 100 and the second image data 200 stored as the calibration data and executes a method of searching an object pixel block as described below. Before executing the method of searching the object pixel block, the first image 100 and the second image 200 are corrected to conform to the same format. In detail, the first image 100 and the second image 200 are corrected such that the width in the lateral direction of each light dot becomes the same.

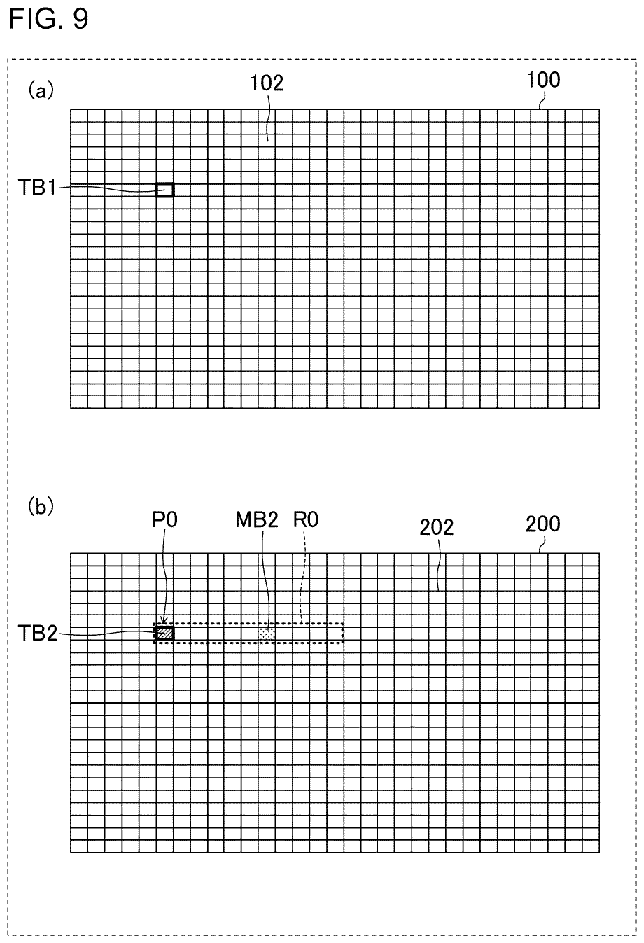

FIG. 9 is a diagram for explaining the method of searching the object pixel block according to the first embodiment. Specifically, FIG. 9(a) schematically illustrates an object pixel block TB1 set on the first image 100. FIG. 9(b) schematically illustrates a search range R0 set on the second image 200 to search the object pixel block shown in FIG. 9(a).

In FIG. 9(b), the second image 200 obtained from the second image-capture unit 20 is divided to plural pixel blocks 202 similarly to the first image 100 for convenience. Each of the plural pixel blocks 202 contains the same number of pixel regions as the pixel block 102.

In FIG. 9(a), the object pixel block TB1 is a pixel block 102 that is to be processed among the pixel blocks 102 on the first image 100. In FIG. 9(b), the reference pixel block TB2 is a pixel block 202 on the second image 200 that corresponds to the object pixel block TB1.

The measuring unit 45 identifies the reference pixel block TB2 on the second image 200 in which the reference pixel block TB2 corresponds to the object pixel block TB1. Then, the measuring unit 45 sets the position of the identified reference pixel block TB2 as a reference position P0 of the search range R0, and sets, as the search range R0, the range extending from the reference position P0 in the direction in which the first image-capture unit 10 and the second image-capture unit 20 are apart from each other.

The extending direction of the search range R0 is set in the direction in which a pixel block corresponding to the object pixel block TB1 (a match pixel block MB2) is displaced from the reference position P0 due to the disparity. The search range R0 is set as the range in which eleven (11) pixel blocks 202 are aligned in the right direction from the reference position P0 (the direction corresponding to the X-axis direction in FIG. 1). However, the number of pixel blocks 202 contained in the search range R0 may not be limited to this number.

The measuring unit 45 searches a pixel block corresponding to the object pixel block TB1 (the match pixel block MB2) in the set search range R0. In detail, the measuring unit 45 shifts the search position by each pixel in the right direction from the reference pixel block TB2, while calculating a correlation value between the object pixel block TB1 and the pixel block at each searching position. The correlation value may be, for example, the Sum of Squared Difference (SSD) or the Sum of Absolute Difference (SAD). The measuring unit 45 identifies, as the match pixel block MB2, a pixel block at a search position at with a highest correlation obtained in the search range R0.

Then, the measuring unit 45 obtains a pixel misalignment amount of the match pixel block MB2 with respect to the reference pixel block TB2. Then, the measuring unit 45 calculates a distance to the surface A1s of the object A1 by the triangulation based on the obtained pixel misalignment amount and the distance between the first image-capture unit 10 and the second image-capture unit 20. The measuring unit 45 executes the same processing as above for all pixel blocks 102 (the object pixel blocks TB1) on the first image 100. After having obtained the distance data for all pixel blocks 102, the measuring unit 45 transmits these obtained distance data to an external device via the communication interface 47.

The distance measuring device 1 may be used while being fixed or may be used while, for example, being mounted to an end effector (a grasping portion or the like) of a robot arm working in a factory. Upon the distance measuring device 1 being used on the robot arm, the controller 46 of the distance measuring device 1 receives an instruction to obtain a distance from a robot controller through the communication interface 47 during a working process of the robot arm. In response to this instruction, the controller 46 causes the measuring unit 45 to measure the distance between the end effector and the surface A1s of the object A1 to be handled by the robot arm, and transmits the measured result to the robot controller via the communication interface 47. The robot controller controls an operation of the end effector by a feedback control based on the received distance data. In the case where the distance measuring device 1 is mounted on the end effector of the robot arm as described above, the distance measuring device 1 preferably has a small size and light weight.

### Second Exemplary Embodiment

In accordance with the first embodiment, the low-resolution regions in each of the first image and the second image are replaced by the high-resolution regions in the other of the first image and the second image to enhance the resolution of the distance measuring device. In accordance with a second exemplary embodiment, the resolution of the distance measuring device is enhanced by causing the light projector 30 to project the patterned light 30a corresponding to the first image 100 and the second image 200 captured by the first image-capture unit 10 and the second image-capture unit 20, respectively.

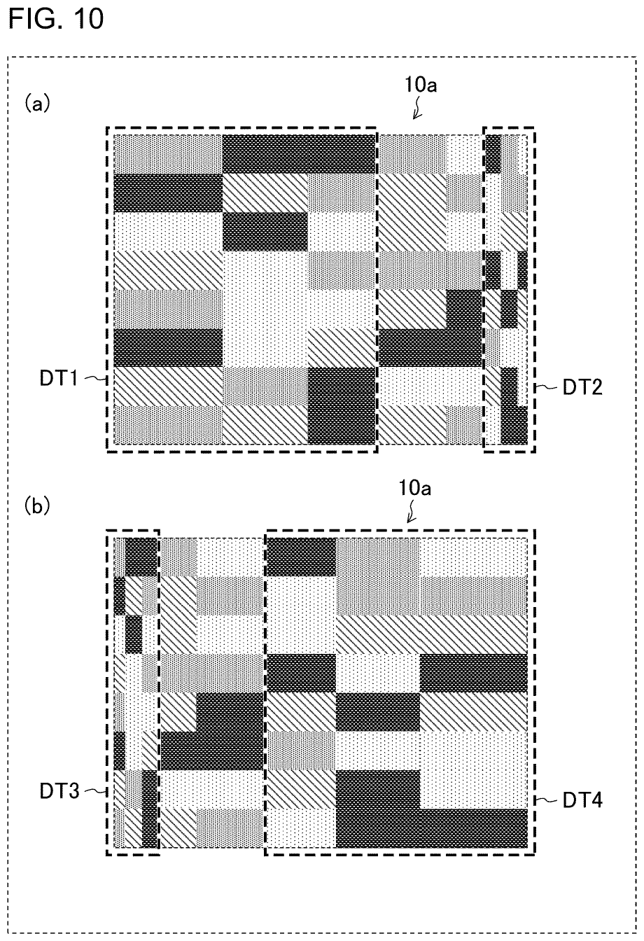

FIG. 10 illustrates an example of the patterned light according to the second embodiment. Specifically, FIG. 10(a) shows the patterned light 30a that is projected when the first image-capture unit 10 captures the first image 100, and FIG. 10(b) shows the patterned light 30a that is projected when the second image-capture unit 20 captures the second image 200.

In FIG. 10(a), the width of the patterned light 30a in the lateral direction decreases from the left end in the figure toward the right end in the figure. In FIG. 10(b), the width of the patterned light 30a in the lateral direction decreases from the right end in the figured toward the left end in the figure. Since each of the first image-capture unit 10 and the second image-capture unit 20 is arranged with respect to the object A1 to satisfy the Scheimpflug condition as described above, the width in the width direction of the light dot closer to the image-capture unit becomes larger and the width in the width direction of the light dot farther from the image-capture unit becomes smaller. Accordingly, the patterned light is projected to decrease the width in the width direction of the light dot closer to the image-capture unit and to increase the width in the width direction of the light dot farther from the image-capture unit. In other words, the first image-capture unit 10 captures the first image when the patterned light shown in FIG. 10(b) is not projected and the patterned light shown in FIG. 10(a) is projected. The second image-capture unit 20 captures the second image when the patterned light shown in FIG. 10(a) is not projected and the patterned light shown in FIG. 10(b) is projected. This configuration makes the width of the light dot constant in each of the first image 100 and the second image 200. The patterned light shown in FIG. 10(a) is thus generated based on the inclination of the surface A1s of the object A1 with respect to the image-capture surface 12a (the sensing surface) of the first image-capture unit 10, and the patterned light shown in FIG. 10(b) is generated based on the inclination of the surface A1s of the object A1 with respect to the image-capture surface 22a (the sensing surface) of the second image-capture unit 20.

In accordance with the second embodiment, the process of generating the calibration data in step S3 shown in FIG. 8 is performed such that the processing of replacing a part of each of the first image 100 and the second image 200 by a part of the other is not executed, and that only the processing of normalizing the first image 100 and the second image 200 is executed.

In accordance with the above embodiments, a movable unit for changing directions of the image-capture lenses 11 and 21 may be additionally provided. This configuration allows the direction of the image-capture lens 11 to be changed depending on the direction of the surface A1s of the object A1 to arrange the first image-capture unit 10, the second image-capture unit 20, and the object A1 to satisfy the Scheimpflug condition with respect to any direction of the surface A1s of the object A1.

The light projector 30 includes three light sources 31 to 33 configured to emit light beams having wavelength bands different from one another in accordance with the above embodiments, the light projector 30 may include one or more light sources.

### REFERENCE MARKS IN DRAWINGS

1 distance measuring device
10 first image-capture unit
20 second image-capture unit
11, 21 image-capture lens (lens)
12, 22 image-capture element
12a, 22a image-capture surface (sensing surface)
30 light projector
30a patterned light
31 to 33 light source
45 measuring unit

1. A distance measuring device comprising:
a light projector configured to project light containing light beams having wavelength bands different from one another;
a first image-capture unit and a second image-capture unit arranged to have fields of view thereof overlapping each other; and
a lens configured to form an image of an object on a sensing surface of the first image-capture unit, wherein
the light projector is configured to project patterned light on an area in which the object exists and the fields of view of the first image-capture unit and the second image-capture unit overlap each other, the patterned light containing the light beams distributed in a predetermined pattern, and
the sensing surface of the first image-capture unit and a principal plane of the lens are not parallel to each other.

2. The distance measuring device according to claim 1, wherein the sensing surface of the first image-capture unit, the principal plane of the lens, and a surface of the object are arranged so as to satisfy a Scheimpflug condition.

3. The distance measuring device according to claim 1, further comprising a measuring unit configured to:
measure a distance to a surface of the object on which the patterned light is projected based on a first image captured by the first image-capture unit and a second image captured by the second image-capture unit, and
interpolate the second image based on the first image.

4. The distance measuring device according to claim 1, further comprising
a measuring unit configured to measure a distance to a surface of the object on which the patterned light is projected based on a first image captured by the first image-capture unit and a second image captured by the second image-capture unit, wherein
the light projector is configured to project first patterned light and second patterned light, the first patterned light being generated based on an inclination of the surface of the object with respect to the sensing surface of the first image-capture unit, the second patterned light being generated based on an inclination of the surface of the object with respect to a sensing surface of the second image-capture unit,
the first image-capture unit is configured to capture the first image when the first patterned light is projected, and
the second image-capture unit is configured to capture the second image when the second patterned light is projected.

5. The distance measuring device according to claim 1, further comprising a movable unit configured to change a direction of the lens.
